(19) United States
(12) Patent Application Publication
(10) Pub. No.: US 2014/0346854 A1
(43) Pub. Date: Nov. 27, 2014

(54) BRAKING SYSTEM

(71) Applicant: CATERPILLAR GLOBAL MINING LLC, South Milwaukee, WI (US)

(72) Inventors: Brian D. Horton, Wilmette, IL (US); Harold D. Dabbs, Peoria, IL (US); Derek W. Holmes, Tuscola, IL (US); Jason D. Martin, Canonsburg, PA (US)

(73) Assignee: CATERPILLAR GLOBAL MINING LLC, South Milwaukee, WI (US)

(21) Appl. No.: 13/900,896

(22) Filed: May 23, 2013

(51) Int. Cl. B60T 13/68; B60T 13/58; B60T 13/14

(52) U.S. Cl. CPC B60T 13/686; B60T 13/141; B60T 13/58
USPC 303/13; 303/30

(57) ABSTRACT

A braking system for a machine including an accumulator configured to receive a pressurized fluid for storage thereof. A control valve disposed between the accumulator and the brake cylinder, the control valve configured to selectively allow discharged pressurized fluid from the accumulator to a brake cylinder. A pressure sensor disposed upstream of the control valve. Further, a controller configured to determine a pressure change in the accumulator using the pressure sensor during at least one of the pulsations of the control valve and compare the determined pressure change with a pre-determined threshold.

### TECHNICAL FIELD

The present disclosure relates to a braking system for a machine and more particularly relates to a system and method for performing a function check of a braking control system associated with the braking system.

### BACKGROUND

Earthmoving and construction machines often employ hydraulic systems that provide functionality and control to various aspects of the machines. For example, some machines employ hydraulic braking systems to control driving speeds. These hydraulically operated braking systems require a source of pressurized fluid such as a pump and/or an accumulator in order to actuate the brakes.

U.S Patent Application No. 20060091722 discloses a brake apparatus provided with an initial check function that detects whether there is a broken wiring or the like, with respect to an actuator such as an electric motor for performing brake fluid pressure control, or the like. The brake apparatus includes two switching elements in an initial check function section, and detects a broken wiring failure of an actuator by turning on only one of the two switching elements. Therefore, during the initial check, a drive current does not flow through the actuator. Thus, it becomes possible to perform the initial check without operating the actuator. By making it possible to perform the initial check without operating the actuator in this manner, it becomes possible to prevent occurrence of the problem of rush current occurring when the actuator is operated for a short time and the problem of the switching elements being destroyed.

### SUMMARY

In one aspect, a braking system for a machine is disclosed. The braking system includes an accumulator configured to receive a pressurized fluid for storage thereof and a brake cylinder fluidly coupled to the accumulator. Further, a control valve disposed between the accumulator and the brake cylinder, which is configured to selectively allow discharged pressurized fluid from the accumulator to the brake cylinder and a pressure sensor disposed upstream of the control valve. The braking system further includes a controller configured to determine a pressure change in the accumulator using the pressure sensor during at least one of the pulsations of the control valve. The controller is operative to compare the determined pressure change with a pre-determined threshold.

In another aspect, a method of operating a braking system is disclosed. The method includes pulsating the control valve to allow the accumulator to selectively discharge pressurized fluid to the brake cylinder and determining the pressure change in the accumulator during at least one of the pulsations of the control valve. Method further includes comparing the determined pressure change with the pre-determined threshold.

### BRIEF DESCRIPTION OF THE DRAWINGS

FIG. 1 illustrates side view of a machine;

FIG. 2 illustrates a hydraulic circuit of a braking system for machine of FIG. 1;

FIG. 3 illustrates a graphical representation of a pressure curve during a function check of a braking control system; and

FIG. 4 illustrates an exemplary method flow chart for performing the function check of the braking control system.

### DETAILED DESCRIPTION

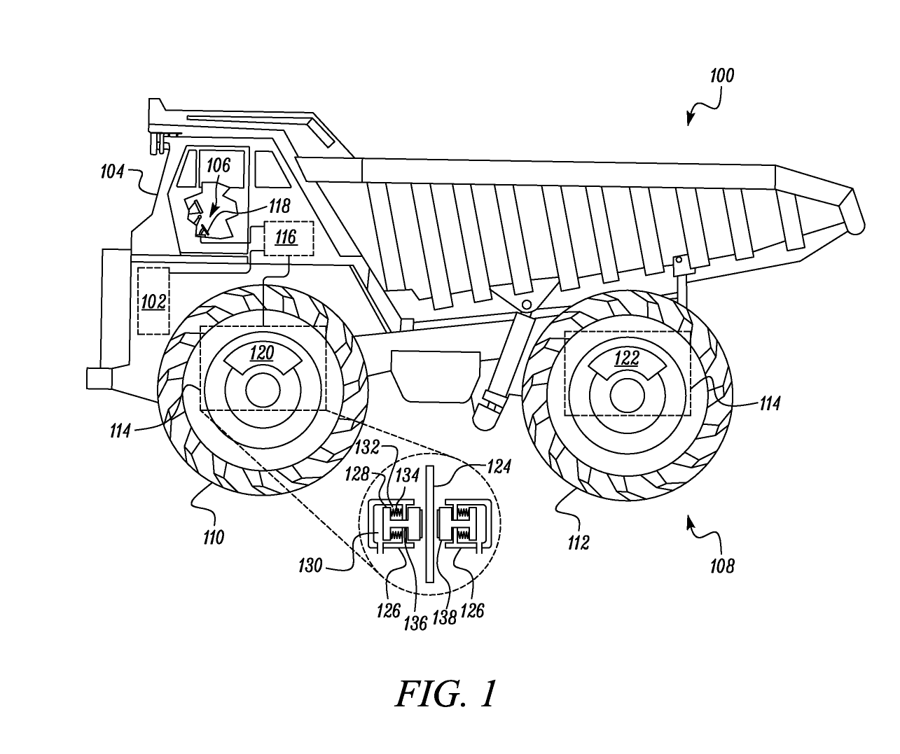

The present disclosure relates to a system and method for performing function check of a braking control system of a machine. FIG. 1 illustrates a machine 100 in accordance with an aspect of the present disclosure. In an exemplary embodiment, the machine 100 may embody an off-highway truck such as those used for construction, mining, or quarrying. The machine 100 includes a power source 102, and an operator station or cab 104 housing various controls necessary to operate the machine 100, such as, for example, operator input devices 106 for controlling the movement of the machine 100. The operator input devices 106 may include, steering devices, joysticks, foot pedals, or the like disposed within the cab 104 and adapted to receive an input from an operator indicative of an operator desired movement of the machine 100.

The power source 102 may power a drive system 108 that may include ground engaging members such as front wheels 110 and rear wheels 112 adapted to support and propel the machine 100. The power source 102 may embody an engine such as, for example, a diesel engine, a gasoline engine, a gaseous fuel-powered engine, or any other type of combustion engine well known in the art. It is contemplated that the power source 102 may alternatively embody a non-combustion source of power (not shown) such as, for example, a fuel cell, a power storage device, or another suitable source of power. The power source 102 may produce a mechanical or electrical power output that may be converted to hydraulic power.

The machine 100 further includes a braking system 114 (hereinafter referred as braking system 114) associated with the ground engaging members, the front wheels 110 and rear wheels 112, and adapted to retard or decelerate the movement of the machine 100. The braking system 114 includes a controller 116 which is operatively connected to the power source 102, and the operator input devices 106 and configured to receive various inputs for controlling the movement of the machine 100. The braking system 114 may include brakes, for example, front brakes 120 and rear brakes 122 associated with the front wheels 110 and the rear wheels 112, respectively, and may be operable using the operator input devices 106, such as, for example, a brake pedal 118 disposed within the cab 104. Thus, the front brakes 120 and rear brakes 122 may selectively retard or decelerate movement of the machine 100.

The brakes 120, 122 may be hydraulically driven and include, but not limited to, hydraulic pressure-actuated brakes, such as, for example, a disk brake or a drum brake that is disposed intermediate to the wheels 110, 112 and a final drive assembly (not shown) of the machine 100. In an exemplary embodiment, as shown in FIG. 1, the brakes 120, 122 may include a brake disk 124 and a pair of brake cylinders 126. The brake disk 124 may be connected to the wheels 110, 112. Each of the brake cylinders 126 includes a piston 128 to define a head side chamber 130 and a rod side chamber 132. A compression spring 134 may be disposed in the rod side chamber 132. Further, a rod 136 is connected to the piston 128 and supports a brake pad 138. During application of the brakes 120, 122, a pressurized fluid supplied in the head side chamber 130 to move the piston 128 to engage the brake pads 138 onto the brake disk 124. The braking system 114 may also include a hydro-mechanical braking system, such as a parking brake associated with the wheels 110, 112 which may be a spring applied brake well known in the art.

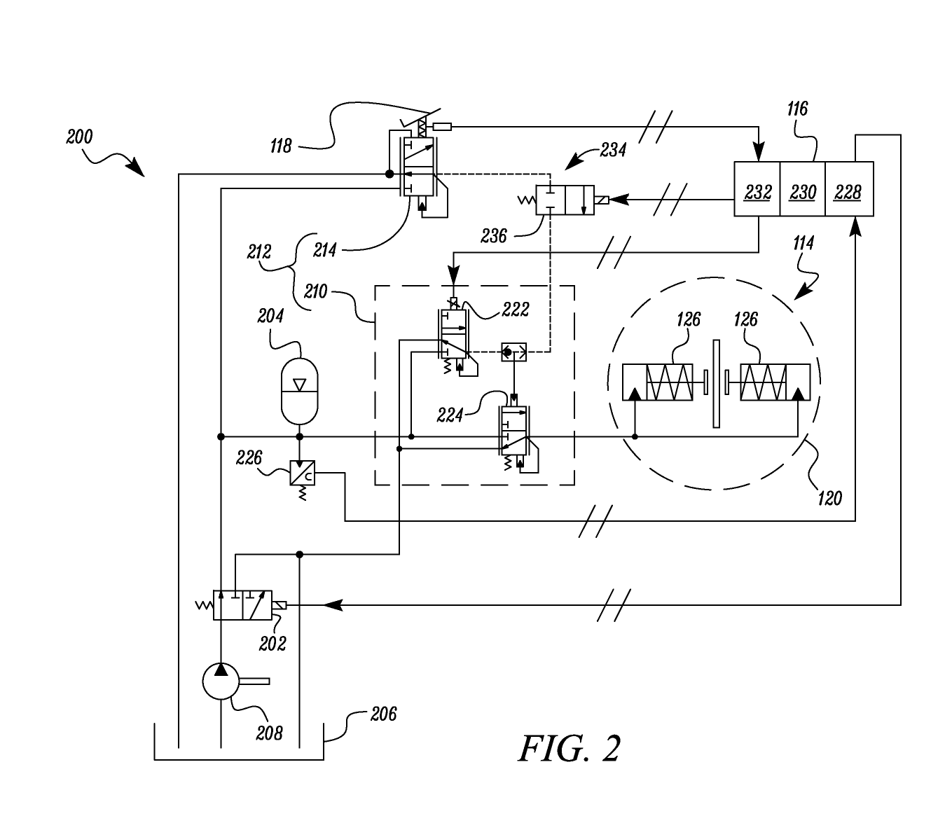

FIG. 2 illustrates an exemplary hydraulic circuit 200 of the braking system 114 for machine 100. For the simplicity purpose only a portion of the hydraulic circuit 200 associated with one of the front brake 120 is illustrated in FIG. 2. It will be apparent to a person having ordinary skill in the art that a similar hydraulic circuit may be associated with the all the front and rear brakes 120, 122.

The hydraulic circuit 200 may include a charging valve 202 associated with one or more accumulators, such as an accumulator 204. The hydraulic circuit 200 further include a fluid reservoir or tank 206, a fluid source or pump 208 adapted to pressurize fluid drawn from the tank 206 and supply to the accumulator 204 for storage thereof. In an exemplary embodiment, the tank 206 may constitute a low-pressure reservoir adapted to hold a supply of fluid. The fluid may include, for example, a hydraulic oil, a lubrication oil, or any other fluid known in the art. The pump 208 is in fluid communication with the front brakes 120 via a braking control system 212. The braking control system 212 may include a control valve 210 and an operator pedal valve 214. The control valve 210 may be a solenoid control valve, and relay control valve, a manually operated control valve, a pneumatic control valve, or a combination of these or other valves as appreciated by those skilled in the art. The control valve 210 is disposed between the front brakes 120 and the accumulator 204 and configured to selectively allow discharged pressurized fluid from the accumulator 204 to the brake cylinders 126 of the front brakes 120. In an embodiment, the pump 208 may be drivably connected to an output shaft of the power source 102, for example, by a counter shaft, a belt, an electric circuit, or in any other suitable manner. Alternatively, the pump 208 may be indirectly connected to the power source 102 via a torque converter, a reduction gearbox, or in any other suitable manner.

In an embodiment, the pump 208 embodies a variable displacement pump with load sensing capabilities, which permits the pump 208 to only operate or provide pressurized fluid flow when necessary, thus improving the efficiency of the machine 100. In another embodiment, the pump 208 may embody a fixed displacement pump.

The charging valve 202 may include a directional control valve adapted to maintain the pressure within the accumulator 204 at a first pre-determined pressure P1. In an embodiment, the charging valve 202 may be a three ports, two position direction control valve. In the illustrated embodiment, during a charging mode, when the pressure within the accumulator 204 decreases below the first pre-determined pressure P1, the charging valve 202 moves to a left-side position (as shown in FIG. 2) such that the flow of the pressurized fluid from the pump 208 to the accumulator 204 initiates. Further, when the pressure within the accumulator 204 reaches the first pre-determined pressure P1, the charging valve 202 moves to a right-side position such that the flow of the pressurized fluid from the pump 208 to the accumulator 204 ceases. It will be apparent to a person having ordinary skill in the art that the first pre-determined pressure P1 may be a range of pressure values or a specific pressure value based on the requirements of the braking system 114.

In an embodiment, the hydraulic circuit 200 may also include a relief valve to protect the accumulator 204 from being over charged or over-pressurized. Moreover, an orifice may be provided to restrict a rate of flow of the pressurized fluid to the accumulator 204.

According to an embodiment of the present disclosure, the control valve 210 may include a pilot valve 222 and a relay valve 224 associated with the front brake 120 of the machine 100. The pilot valve 222 may be a solenoid operated valve configured to receive an actuation signal from the controller 116 in response to the input from the operator via the brake pedal 118. The actuation signal may be a voltage or current signal such that, the pilot valve 222 may send a hydraulic pilot signal to the relay valve 224 to fluidly couple the brake cylinders 126 of the front brake 120 to the accumulator 204.

A pressure sensor 226 may be disposed in a location in order to indicate the pressure in the accumulator 204. According to an embodiment of the present disclosure, the pressure sensor 226 is disposed upstream of the control valve 210. The pressure sensor 226 may be adapted to communicate a signal indicative of the pressure within the accumulators 204 to the controller 116. The pressure sensor 226 may be a piezoresistive strain gauge, a piezoelectric, a capacitive, an electromagnetic sensor, or any type of pressure transducer well known in the art. The controller 116 may include a signal input unit 228, a system memory 230, and a processor 232. The signal input unit 228 may be configured to receive a voltage or current signals from the pressure sensor 226 corresponding to a real time pressure within the accumulators 204.

The system memory 230 may include for example, but not limited to, a Random Access Memory (RAM), a Read Only Memory (ROM), flash memory, a data structure, and the like. According to an embodiment, the system memory 230 may include a computer executable code to perform a function check of the braking control system 212. Moreover, the system memory 230 may store the one or more real time inputs and/or signals. In one embodiment, the system memory 230 may store the first pre-determined pressure P1. The system memory 230 may be operable on the processor 232 to output a pulsating actuation signals to perform the function check in a sequence with each having a pre-determined time interval T. The pulsating actuation signals pulsates the control valve 210 and actuate a discharge mode of the accumulator 204 to allow discharged pressurized fluid from the accumulator 204 to the brake cylinders 126 during each of the pre-determined time interval T. Further, the processor 232 is configured to determine a pressure change ΔP in the accumulator 204 during at least one of the pulsations of the control valve 210 during the pre-determined time interval T using the pressure sensor 226 and compare the pressure change ΔP with a pre-determined threshold. Accordingly, the controller 116 may detect a first condition or a second condition of the control valve 210.

Moreover, the system memory 230 may also include a computer executable code to determine the charging mode associated with the accumulator 204, such that during the charging mode of the accumulator 204 the controller 116 does not perform the function check of the braking control system 212. Further, the controller 116 may perform the function check only when the pressure in the accumulator 204 reaches to the first pre-determined pressure P1 after the charging mode.

According to an embodiment, the controller 116 detects the first condition of the control valve 210 when the pressure change ΔP is greater than the pre-determined threshold, which is indicative of a normal working of the control valve 210 or healthy braking control system 212. Alternatively, the controller 116 detects the second condition of the control valve 210 when pressure change ΔP is equal to or less than the pre-determined threshold, which is indicative of a malfunction in the control valve 210 or unhealthy braking control system 212.

Further, when the second condition of the control valve 210 is detected, the controller 116 may provide a feedback indicative of the malfunction in the control valve 210 to the operator using the operator input devices 106. In an exemplary embodiment, the feedback may include an audio and/or visual feedback to the operator. In another embodiment the controller may take an pre-determined action based on the detected second condition. In an embodiment, the controller 116 may be operatively connected to a hydro-mechanical braking system 234 with the wheels 110, 112. The hydro-mechanical braking system 234 may include a pilot valve 236. According to an embodiment of the present disclosure, upon detection of the second condition of the control valve 210, the hydro-mechanical braking system 234 is enabled by the controller 116. As illustrated in FIG. 2, the pilot valve 236 is a two ports, two position direction control valve such that upon detection of the second condition the pilot valve 236 is moved to right side position to enable the operator pedal valve 214.

Numerous commercially available microprocessors can be configured to perform the functions of the controller 116. It should be appreciated that the controller 116 could readily embody a general machine controller capable of controlling numerous other functions of the machine 100. Various known circuits may be associated with the controller 116, including signal-conditioning circuitry, communication circuitry, and other appropriate circuitry. It should also be appreciated that the controller 116 may include one or more of an application-specific integrated circuit (ASIC), a field-programmable gate array (FPGA), a computer system, and a logic circuit configured to allow the controller 116 to perform function check in accordance with the present disclosure.

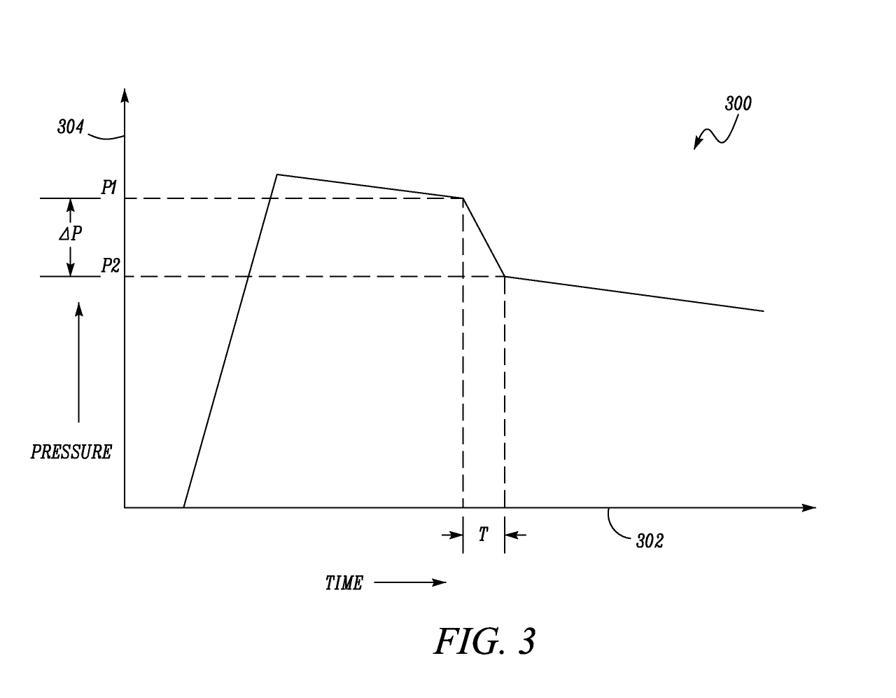

FIG. 3 illustrates a graphical representation of a pressure curve 300 during the function check of the braking control system 212 in the hydraulic circuit 200 of the braking system 114. As illustrated, time is plotted along a horizontal axis 302 and pressure in the accumulator 204 is plotted along a vertical axis 302. In an aspect of the present disclosure, during each of the pre-determined time interval T the pressure in the accumulator 204 decreases from the first pre-determined pressure P1 to a second pre-determined pressure P2. Further the pressure change ΔP based on a difference of the first pre-determined pressure P1 and the second pre-determined P2 is monitored during each of the pre-determined time interval T to detect the first condition or the second condition of the control valve 210. The malfunction of the control valve 210, more particularly the due to a failure of the pilot valve 222 may cause a reduced flow of the pressurized fluid from the accumulator 204 into the brake cylinder 126. Thus the pressure change ΔP based on a difference of the first pre-determined pressure P1 and the second pre-determined P2 may be equal or less then the pre-determined threshold and provides the indication of the malfunction in the control valve 210 or the associated pilot valve 222.

### INDUSTRIAL APPLICABILITY

The industrial applicability of the system and method for performing a function check of the braking control system in the hydraulic circuit for a braking system described herein will be readily appreciated from the foregoing discussion. Although, the machine 100 is shown as a large mining truck, the machine 100 may be any wheeled or tracked machine that performs at least one operation associated with for example mining, construction, and other industrial applications, for example, backhoe loaders, skid steer loaders, wheel loaders, motor graders, track-type tractor, and many other machines.

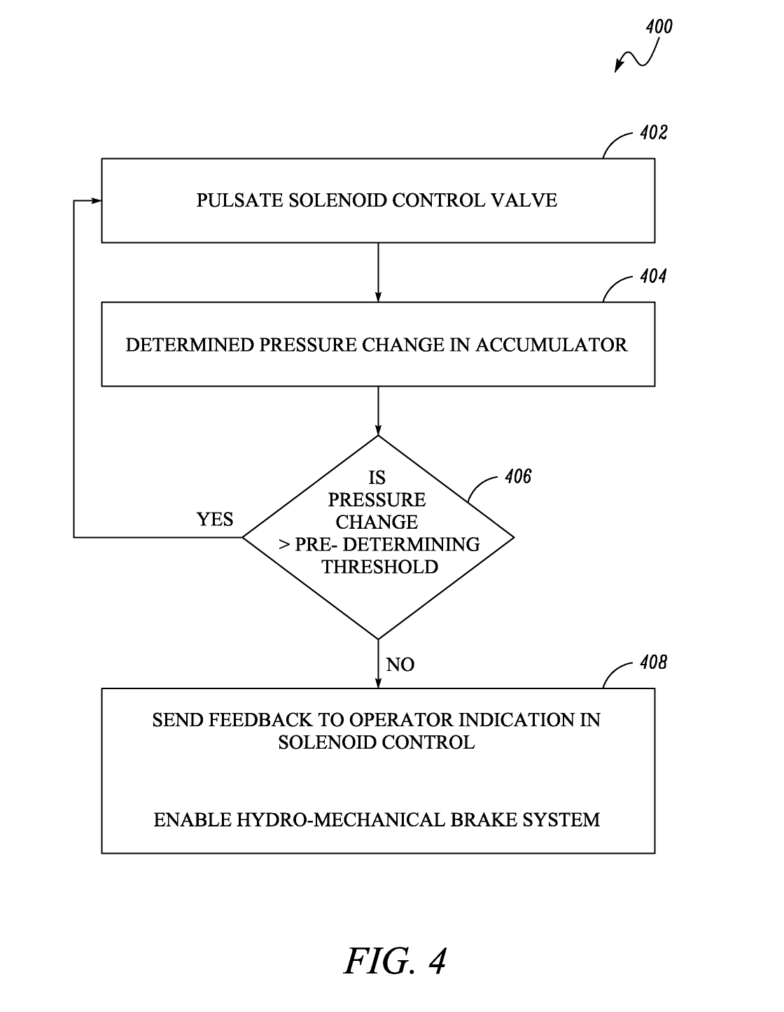

FIG. 4 illustrates an exemplary method flow chart 400 for performing the function check of the braking control system 212 in the hydraulic circuit 200 of the braking system 114. At step 402 the controller pulsates the control valve 210 and selectively allow discharged pressurized fluid from the accumulator 204 to the brake cylinder 126. According to an embodiment, the controller 116 may determine the pressure in the accumulator 204 as it reaches to the first pre-determined pressure P1 and output the actuation signal as a pulse signal with a frequency corresponding to the pre-determined time interval T to selectively supply to at least one of the pilot valves 222 associated control valve 210. The pilot valves 222, accordingly, change the spool position of the respective relay valves 224 to allow discharged pressurized fluid from the accumulator 204 to the brake cylinder 126. At step 404, the controller 116 may determined the pressure change ΔP in the accumulator 204 during at least one of the pulsations of the control valve 210 during the pre-determined time interval T using the pressure sensor 226, and determine if the pressure change ΔP is greater than the pre-determined threshold at the following step 406. The pre-determined threshold may be a based on a sample data in the pressure change ΔP, or calibrated valve based on design and application requirement of the braking system 114.

In case the pressure change ΔP is greater than the pre-determined threshold (step 406: YES), the controller 116 detects the first condition of the control valve 210 which is indicative of the normal working of the valve and the method 400 goes back to step 402 for again performing the function check for the pre-selected number of pre-determined time intervals T. Otherwise, in case the pressure change ΔP is equal to less than the pre-determined threshold (step 406: NO), the method 400 goes step 408. At step 408, the controller may send a feedback to the operator using operator input devices 106 indicating the malfunction in the control valve 210 and also enable the hydro-mechanical brake system 234 as a back-up braking system. It will be apparent to a person having ordinary skill in the art that the malfunction of the control valve 210 may be due to an electrical failure, faulty pilot valves 222, or fluid leakage.

According to an embodiment, by using the pressure sensor 226 provided upstream of the control valve 210 may provide relatively less complex and relatively inexpensive solution for preforming the function check. Moreover, the present system may be retrofittable to the existing braking systems without much of hardware and control system integration requirements.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

What is claimed is:

1. A braking system for a machine comprising:
an accumulator configured to receive a pressurized fluid for storage thereof;
a brake cylinder fluidly coupled to the accumulator;
a control valve disposed between the accumulator and the brake cylinder, the control valve configured to selectively allow discharged pressurized fluid from the accumulator to the brake cylinder;
a pressure sensor disposed upstream of the control valve; and
a controller configured to:
determine a pressure change in the accumulator using the pressure sensor during at least one of the pulsations of the control valve; and
compare the determined pressure change with a pre-determined threshold.

2. The braking system of claim 1, wherein the controller is further configured to detect at least one of:
a first condition of the control valve when the pressure change is greater than or equal to the pre-determined threshold; and
a second condition of the control valve when the pressure change is substantially less than the pre-determined threshold.

3. The braking system of claim 2 further comprising a hydro-mechanical braking system, wherein the controller is configured to enable the hydro-mechanical braking system upon detection of the second condition of the control valve.

4. The braking system of claim 2, wherein the first condition of the control valve is indicative of a normal working of the control valve.

5. The braking system of claim 2, wherein the second condition of the control valve is indicative of a malfunction in the control valve.

6. The braking system of claim 5, wherein the controller is configured to provide a feedback indicative of the malfunction in the control valve.

7. The braking system of claim 1, wherein the controller is configured to pulsate the control valve to allow discharged pressurized fluid from the accumulator to the brake cylinder.

8. The braking system of claim 1, wherein the control valve includes a pilot valve configured to receive an actuation signal from the controller during a pre-determined time interval to pulsate the control valve.

9. A machine comprising:
one or more ground engaging members; and
a braking system associated with the one or more ground engaging members, the braking system including:
an accumulator configured to receive a pressurized fluid for storage thereof;
a brake cylinder fluidly coupled to the accumulator;
a control valve disposed between the accumulator and the brake cylinder, the control valve configured to selectively allow discharged pressurized fluid from the accumulator to the brake cylinder;
a pressure sensor disposed upstream of the control valve; and a controller configured to:
determine a pressure change in the accumulator using the pressure sensor during at least one of the pulsations of the control valve; and
compare the determined pressure change with a pre-determined threshold.

10. The machine of claim 9, wherein the controller is further configured to detect at least one of:
a first condition of the control valve when the pressure change is greater than or equal to the pre-determined threshold; and
a second condition of the control valve when the pressure change is substantially less than the pre-determined threshold.

11. The machine of claim 10, further comprising a hydro-mechanical braking system associated with the one or more ground engaging members, wherein the controller is configured to enable the hydro-mechanical braking system upon detection of the second condition of the control valve.

12. The machine of claim 10, wherein the first condition of the control valve is indicative of a normal working of the control valve.

13. The machine of claim 10, wherein the second condition of the control valve is indicative of a malfunction in the control valve.

14. The machine of claim 13, wherein the controller configured to provide a feedback indicative of the malfunction in the control valve.

15. The machine of claim 9, wherein the controller is configured to pulsate the control valve to allow discharged pressurized fluid from the accumulator to the brake cylinder.

16. The machine of claim 9, wherein the control valve includes a pilot valve configured to receive an actuation signal from the controller during a pre-determined time interval to pulsate the control valve.

17. A method of operating a braking system comprising:
pulsating a control valve to allow an accumulator to discharge a pressurized fluid into a brake cylinder, the control valve disposed between the accumulator and the brake cylinder;
determining a pressure change in the accumulator during at least one of the pulsations of the control valve; and
comparing the determined pressure change with a pre-determined threshold.

18. The method of claim 17 further comprising at least one of:
detecting a first condition of the control valve when the pressure change is greater than the pre-determined threshold; and
detecting a second condition of the control valve when the pressure change is substantially equal to or less than the pre-determined threshold.

19. The method of claim 18 further comprises enabling a hydro-mechanical braking system upon detecting the second condition of the control valve.

20. The method of claim 18, wherein the first condition of the control valve is indicative of a normal working of the control valve and the second condition of the control valve is indicative of a malfunction in the control valve.
